(19) United States
(12) Patent Application Publication
(10) Pub. No.: US 2010/0128834 A1
(43) Pub. Date: May 27, 2010

(54) ZIRCONIUM ALLOYS WITH IMPROVED CORROSION RESISTANCE AND METHOD FOR FABRICATING ZIRCONIUM ALLOYS WITH IMPROVED CORROSION RESISTANCE

(75) Inventors: David Colburn, Columbia, SC (US); Robert Comstock, Irwin, PA (US); Terrence Cook, Riverdale, UT (US); Mats Dahlback, Vasteras (SE); John P. Foster, Bluffton, SC (US); Anand Garde, Columbia, SC (US); Pascal Jourdain, Vasteras (SE); Ronald Kesterson, Columbia, SC (US); Micheal McClarren, New Alexandria, PA (US); Lynn Nuhfer, Pittsburgh, PA (US); Jonna Partezana, Finleyville, PA (US); Kenneth Yueh, Columbia, SC (US); James A. Boshers, Marshville, NC (US); Penney File, Lusby, MD (US)

Correspondence Address: WESTINGHOUSE ELECTRIC COMPANY, LLC, P.O. BOX 355, PITTSBURGH, PA, 15230-0355, US

(73) Assignee: Westinghouse Electric Company LLC, Cranberry Township, PA (US)

(21) Appl. No.: 12/697,322

(22) Filed: Feb. 1, 2010

Related U.S. Application Data
(62) Division of application No. 11/087,844, filed on Mar. 23, 2005.
(60) Provisional application No. 60/555,600, filed on Mar. 23, 2004.
(60) Provisional application No. 60/564,416, filed on Apr. 22, 2004.
(60) Provisional application No. 60/564,417, filed on Apr. 22, 2004.
(60) Provisional application No. 60/564,469, filed on Apr. 22, 2004.

(51) Int. Cl. G21C 3/07; C22C 16/00

(52) U.S. Cl. 376/412; 420/423; 420/422; 148/421

(57) ABSTRACT

Articles, such as tubing or strips, which have excellent corrosion resistance to water or steam at elevated temperatures, are produced from alloys having 0.2 to 1.5 weight percent niobium, 0.01 to 0.45 weight percent iron, at least one additional alloy element selected from 0.02 to 0.8 weight percent tin, 0.05 to 0.5 weight percent chromium, 0.02 to 0.3 weight percent copper, 0.1 to 0.3 weight percent vanadium, 0.01 to 0.1 weight percent nickel, the balance at least 97 weight percent zirconium, including impurities, wherein the alloy may be fabricated from a process of forging the zirconium alloy into a material, beta quenching the material, forming the material by extruding or hot rolling the material, cold working the material with one or a multiplicity of cold working steps, wherein the cold working step includes cold reducing the material and annealing the material at an intermediate anneal temperature of 960°-1105° F., and final working and annealing of the material. The articles formed also show improved weld corrosion resistance with the addition of chromium.

### CROSS-REFERENCE TO RELATED APPLICATIONS

The present application is a divisional of U.S. patent application Ser. No. 11/087,844, filed Mar. 23, 2005, which claims priority from U.S. Provisional Application Ser. No. 60/555,600, filed Mar. 23, 2004, and Provisional Application Nos. 60/564,416, 60/564,417 and 60/564,469, each filed Apr. 22, 2004, the disclosures of all of which are incorporated herein by reference.

### FIELD OF THE INVENTION

The present invention generally relates to a zirconium based alloy usable for the formation of strips and tubing for use in nuclear fuel reactor assemblies and a method for making same. Specifically, the invention relates to zirconium based alloys that exhibit improved corrosion resistance in water based reactors under elevated temperatures, and a method of forming the alloys that increases corrosion resistance by decreasing intermediate anneal temperatures. The invention further relates to zirconium based alloys that include the addition of the alloying element chromium to improve weld corrosion resistance.

### BACKGROUND OF THE INVENTION

In the development of nuclear reactors, such as pressurized water reactors and boiling water reactors, fuel designs impose significantly increased demands on all of the fuel components, such as cladding, grids, guide tubes, and the like. Such components are conventionally fabricated from zirconium-based alloys commercially titled ZIRLO, corrosion resistant alloys that contain about 0.5-2.0 wt. % Nb; 0.9-1.5 wt. % Sn; and 0.09-0.11 wt. % of a third alloying element selected from Mo, V, Fe, Cr, Cu, Ni, or W, with the rest Zr, as taught in U.S. Pat. No. 4,649,023 (Sabol et al.) That patent also taught compositions containing up to about 0.25 wt. % of the third alloying element, but preferably about 0.1 wt. %. Sabol et al., in “Development of a Cladding Alloy for High Burnup” Zirconium in the Nuclear Industry: Eighth International Symposium, L. F. Van Swan and C. M. Eucken, Eds., American Society for Testing and Materials, ASTM STP 1023, Philadelphia, 1989. pp. 227-244, reported improved properties of corrosion resistance for ZIRLO (0.99 wt. % Nb, 0.96 wt. % Sn, 0.10 wt. % Fe, remainder primarily zirconium) relative to Zircaloy-4.

There have been increased demands on such nuclear core components, in the form of longer required residence times and higher coolant temperatures, both of which cause increase alloy corrosion. These increased demands have prompted the development of alloys that have improved corrosion and hydriding resistance, as well as adequate fabricability and mechanical properties.

Aqueous corrosion in zirconium alloys is a complex, multi-step process. Corrosion of the alloys in reactors is further complicated by the presence of an intense radiation field which may affect each step in the corrosion process. In the early stages of oxidation, a thin compact black oxide film develops that is protective and retards further oxidation. This dense layer of zirconia exhibits a tetragonal crystal structure which is normally stable at high pressure and temperature. As the oxidation proceeds, the compressive stresses in the oxide layer cannot be counterbalanced by the tensile stresses in the metallic substrate and the oxide undergoes a transition. Once this transition has occurred, only a portion of the oxide layer remains protective. The dense oxide layer is then renewed below the transformed oxide. A new dense oxide layer grows underneath the porous oxide. Corrosion in zirconium alloys is characterized by this repetitive process of growth and transition. Eventually, the process results in a relatively thick outer layer of non-protective, porous oxide. There have been a wide variety of studies on corrosion processes in zirconium alloys. These studies range from field measurements of oxide thickness on irradiated fuel rod cladding to detailed micro-characterization of oxides formed on zirconium alloys under well-controlled laboratory conditions. However, the in-reactor corrosion of zirconium alloys is an extremely complicated, multi-parameter process. No single theory has yet been able to completely define it.

Corrosion is accelerated in the presence of lithium hydroxide. As pressurized water reactor (PWR) coolant contains lithium, acceleration of corrosion due to concentration of lithium in the oxide layer must be avoided: Several disclosures in U.S. Pat. Nos. 5,112,573 and 5,230,758 (both Foster et al.) taught an improved ZIRLO composition that was more economically produced and provided a more easily controlled composition while maintaining corrosion resistance similar to previous ZIRLO compositions. It contained 0.5-2.0 wt. % Nb; 0.7-1.5 wt. % Sn; 0.07-0.14 wt. % Fe and 0.03-0.14 wt. % of at least one of Ni and Cr, with the rest Zr. This alloy had a 520° C. high temperature steam weight gain at 15 days of no more than 633 mg/dm². U.S. Pat. No. 4,938,920 to Garzarolli teaches a composition having 0-1 wt. % Nb; 0-0.8 wt. % Sn, and at least two metals selected from iron, chromium and vanadium. However, Garzarolli does not disclose an alloy that had both niobium and tin, only one or the other.

Sabol et al. in “In-Reactor Corrosion Performance of ZIRLO and Zircaloy-4,” Zirconium in the Nuclear Industry: Tenth International Symposium, A. M. Garde and E. R. Bradley Eds., American Society for Testing and Materials, ASTM STP 1245, Philadelphia 1994, pp. 724-744, demonstrated that, in addition to improved corrosion performance, ZIRLO material also has greater dimensional stability (specifically, irradiation creep and irradiation growth) than Zircaloy-4.

More recently, U.S. Pat. No. 5,560,790 (Nikulina et al.) taught zirconium-based materials having high tin contents where the microstructure contained Zr—Fe—Nb particles. The alloy composition contained: 0.5-1.5 wt. % Nb; 0.9-1.5 wt. % Sn; 0.3-0.6 wt. % Fe, with minor amounts of Cr, C, O and Si, with the rest Zr. U.S. Pat. No. 5,940,464 (Mardon et al.) taught zirconium alloy tubes for forming the whole or outer portion of a nuclear fuel cladding or assembly guide tube having a low tin composition: 0.8-1.8 wt. % Nb; 0.2-0.6 wt. % Sn, 0.02-0.4 wt. % Fe, with a carbon content of 30-180 ppm, a silicon content of 10-120 ppm and an oxygen content of 600-1800 ppm, with the rest Zr. Mardon et al. taught a broad range of Sn versus Fe contents, that is, at 0.2 wt. % Sn, Fe is 0.2 wt. % to 0.4 wt. % and at 0.6 wt. % Sn, Fe is 0.2 wt. % to 0.4 wt. %; with a preferred range of Sn being 0.25 wt. % to 0.35 wt. % and of Fe being 0.2 wt. % to 0.3 wt. %.

While these modified zirconium based compositions are claimed to provide improved corrosion resistance as well as improved fabrication properties, economics have driven the operation of nuclear power plants to higher coolant temperatures, higher burnups, higher concentrations of lithium in the coolant, longer cycles, and longer in-core residence times that have resulted in increased corrosion duty for the cladding. Continuation of this trend as burnups approach and exceed 70,000 MWd/MTU will require further improvement in the corrosion properties of zirconium based alloys. The alloys of this invention provide such corrosion resistance.

Another potential way to increase corrosion resistance is through the method of forming of alloy itself. To form alloy elements into a tubing or strip, ingots are conventionally vacuum melted and beta quenched, and thereafter formed into an alloy through a gauntlet of reductions, intermediate anneals, and final anneals, wherein the intermediate anneal temperature is typically above 1105° F. for at least one of the intermediate anneals. In U.S. Pat. No. 4,649,023 to Sabol et al., the ingots are extruded into a tube after the beta quench, beta annealed, and thereafter alternatively cold worked in a pilger mill and intermediately annealed at least three times. While a broad range of intermediate anneal temperatures are disclosed, the first intermediate anneal temperature is preferably 1112° F., followed by later intermediate anneal temperature of 1076° F. The beta annealing step preferably uses temperatures of about 1750° F. In U.S. Pat. No. 5,230,758, three intermediate anneal temperatures were preferably 1100° F., 1250° F., and 1350° F., respectively. U.S. Pat. No. 5,887,045 to Mardon discloses an alloy forming method having at least two intermediate annealing steps carried out between 1184° to 1400° F. No attempts were made, however, to link the intermediate anneal temperatures to corrosion resistance.

A further issue in nuclear reactors is corrosion of welds utilized in a nuclear fuel assembly. In a typical fuel rod, nuclear fuel pellets are placed within the cladding, which is enclosed by end caps on either end of the cladding, such that the end caps are welded to the cladding. The weld connecting the end caps to the cladding, however, generally exhibits corrosion to an even greater extent than the cladding itself, usually by a factor of two over non-welded metal. Rapid corrosion of the weld creates an even greater safety risk than the corrosion of non-welded material, and its protection has previously been ignored. In addition, grids have many welds and the structural integrity depends on adequate weld corrosion resistance.

Thus, there continually remains a need for novel zirconium alloys that exhibit improved corrosion resistance over known alloys in the field, and improved welds for holding end caps on claddings and for joining grid straps that likewise exhibit increased corrosion resistance.

### SUMMARY OF THE INVENTION

Accordingly, an object of the present invention is to provide zirconium alloys with improved corrosion resistance through improved alloy chemistry, improved weld corrosion resistance, and improved method of formation of alloys having reduced intermediate anneal temperatures during formation of the alloys.

It is a further object of the present invention to provide a zirconium based alloy for use in an elevated temperature environment of a nuclear reactor, the alloy having 0.2 to 1.5 weight percent niobium, 0.01 to 0.45 weight percent iron, and at least two additional alloy elements selected from 0.02 to 0.45 weight percent tin, 0.05 to 0.5 weight percent chromium, 0.02 to 0.3 weight percent copper, 0.1 to 0.3 weight percent vanadium, 0.01 to 0.1 weight percent nickel, the remainder at least 97 weight percent zirconium, including impurities.

It is a further object of the present invention to provide a zirconium based alloy for use in an elevated temperature environment of a nuclear reactor, the alloy having 0.4 to 1.5 weight percent niobium, 0.4 to 0.8 weight percent tin, 0.05 to 0.3 weight percent iron, the balance at least 97 weight percent zirconium, including impurities.

It is a further object of the present invention to provide a zirconium based alloy characterized by increased weld corrosion resistance, wherein the increased weld corrosion resistance is resultant from the addition of 0.05 to 0.5 weight percent chromium.

It is a further object of the present invention to provide a process for forming a zirconium alloy, comprising the steps of forging the zirconium alloy into a material for further processing, beta quenching the material, forming the material by extruding or hot rolling the material, cold working the material with one or a multiplicity of cold working steps, wherein the cold working step includes cold milling the material and annealing the material at an intermediate anneal temperature of 960°-1070° F., and finalizing the material.

It is a further object of the present invention to provide a zirconium based alloy, the alloy having 0.2 to 1.5 weight percent niobium, 0.01 to 0.45 weight percent iron, at least one additional alloy element selected from 0.02 to 0.8 weight percent tin, 0.05 to 0.5 weight percent chromium, 0.02 to 0.3 weight percent copper, 0.1 to 0.3 weight percent vanadium, 0.01 to 0.1 weight percent nickel, the balance at least 97 weight percent zirconium, including impurities, wherein the alloy is fabricated from a process of forging the zirconium alloy into a shape suitable for further processing, beta quenching the material, forming the material by extruding or hot rolling the material, cold working the material with one or a multiplicity of reducing steps, wherein the reducing steps include reducing the material and annealing the material at an intermediate anneal temperature of 960°-1070° F., and finalizing the material.

### BRIEF DESCRIPTION OF THE DRAWINGS

FIG. 1A is a process flow diagram of a method for forming zirconium alloy tubing.

FIG. 1B is a process flow diagram of a method for forming zirconium alloy strips.

FIG. 2 is a graph depicting the 680° F. water test weight gain of ZIRLO as a function of autoclave exposure time for material processed with intermediate anneal temperatures of 1085° and 1030° F.

FIG. 3 is a graph depicting the 680° F. water test weight gain of Alloy X1 as a function of autoclave exposure time for material processed with intermediate anneal temperatures of 1085° and 1030° F.

FIG. 4 is a graph depicting the 680° F. water test weight gain of Alloy X4 as a function of autoclave exposure time for material processed with intermediate anneal temperatures of 1085° and 1030° F.

FIG. 5 is a graph depicting the 680° F. water test weight gain of Alloy X5 as a function of autoclave exposure time for material processed with intermediate anneal temperatures of 1085° and 1030° F.

FIG. 6 is a graph depicting the 680° F. water test weight gain of Alloy X6 as a function of autoclave exposure time for material processed with intermediate anneal temperatures of 1085° and 1030° F.

FIG. 7 is a graph depicting the 800° F. steam test weight gain of ZIRLO as a function of autoclave exposure time for material processed with intermediate anneal temperatures of 1085° and 1030° F.

FIG. 8 is a graph depicting the 800° F. steam test weight gain of Alloy X1 as a function of autoclave exposure time for material processed with intermediate anneal temperatures of 1085° and 1030° F.

FIG. 9 is a graph depicting the 800° F. steam test weight gain of Alloy X4 as a function of autoclave exposure time for material processed with intermediate anneal temperatures of 1085° and 1030° F.

FIG. 10 is a graph depicting the 800° F. steam test weight gain of Alloy X5 as a function of autoclave exposure time for material processed with intermediate anneal temperatures of 1085° and 1030° F.

FIG. 11 is a graph depicting the 800° F. steam test weight gain of Alloy X6 as a function of autoclave exposure time for material processed with intermediate anneal temperatures of 1085° and 1030° F.

FIG. 12 is a graph comparing the 800° F. steam weight gain for ZIRLO strip processed with low temperature intermediate and final anneal temperatures.

FIG. 13 is a graph comparing the 680° F. water test weight gain of Alloy X1 to ZIRLO as a function of autoclave exposure time.

FIG. 14 is a graph comparing the 680° F. water test weight gain of Alloy X4 to ZIRLO as a function of autoclave exposure time.

FIG. 15 is a graph comparing the 680° F. water test weight gain of Alloy X5 to ZIRLO as a function of autoclave exposure time.

FIG. 16 is a graph comparing the 680° F. water test weight gain of Alloy X6 to ZIRLO as a function of autoclave exposure time.

### DETAILED DESCRIPTION OF THE PREFERRED EMBODIMENTS

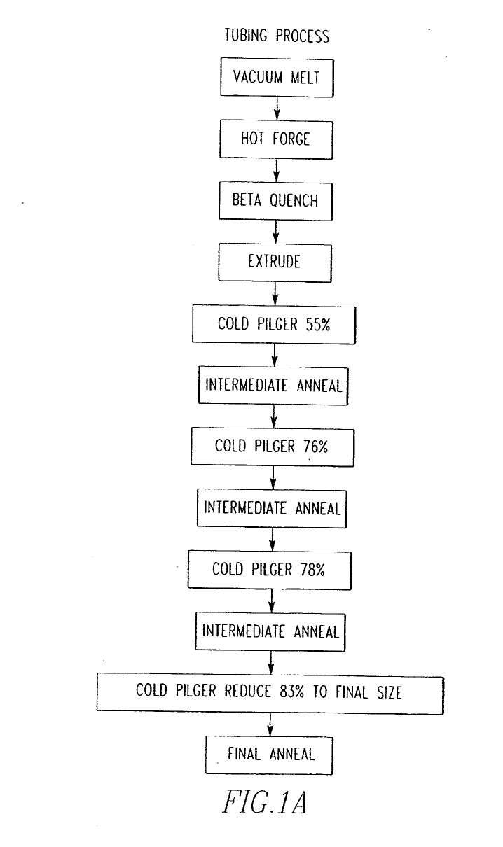

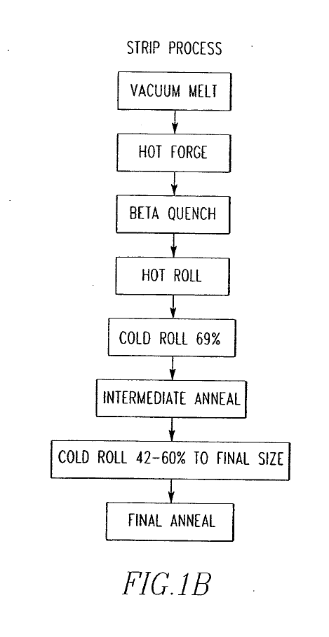

A sequence of steps for forming a cladding, strip, tube or like object known in the art from an alloy of the present invention is shown in FIG. 1. To create tubing for cladding, as shown in FIG. 1A, compositional zirconium based alloys were fabricated from vacuum melted ingots or other like material known in the art. The ingots were preferably vacuum arc-melted from sponge zirconium with a specified amount of alloying elements. The ingots were then forged into a material and thereafter β-quenched. β-quenching is typically done by heating the material (also known as a billet) up to its β-temperature, between around 1273 to 1343K. The quenching generally consists of quickly cooling the material by water. The n-quench is followed by extrusion. Thereafter, the processing includes cold working the tube-shell by a plurality of cold reduction steps, alternating with a series of intermediate anneals at a set temperature. The cold reduction steps are preferably done on a pilger mill. The intermediate anneals are conducted at a temperature in the range of 960° F.-1105° F. The material may be optionally re-β-quenched prior to the final cold roll and formed into an article therefrom.

For tubing, a more preferred sequence of events after extrusion includes initially cold reducing the material in a pilger mill, an intermediate anneal with a temperature of about 1030° to 1105° F., a second cold reducing step, a second intermediate anneal within a temperature range of about 1030° to 1070° F., a third cold reducing step, and a third intermediate anneal within a temperature range of about 1030° to 1070° F. The reducing step prior to the first intermediate anneal is a tube reduced extrusion (TREX), preferably reducing the tubing about 55%. Subsequent reductions preferably reduce the tube about 70-80%. Note that the temperature of a material during the intermediate anneal can be measured directly.

It is preferred that each reduction pass on the pilger mill reduce the material being formed by at least 51%. The material then preferably goes through a final cold reduction. The material may be further processed with a final anneal at temperatures from about 800-1300° F.

To create strip, compositional zirconium based alloys were fabricated from vacuum melted ingots or other like material known in the art. The ingots were preferably arc-melted from sponge zirconium with a specified amount of alloying elements. The ingots were then forged into a material of rectangular cross-section and thereafter β-quenched. Thereafter, the processing as shown in FIG. 1B, includes a hot rolling step after the beta quench, cold working by one or a plurality of cold rolling and intermediate anneal steps, wherein the intermediate anneal temperature is conducted at a temperature from 960° F.-1105° F. The material then preferably goes through a final pass and anneal, wherein the final anneal temperature is in the range of about 800-1300° F.

A more preferred sequence to create the alloy strip includes an intermediate anneal temperature within a range of about 1030° to 1070° F. Further, the pass on the mill preferably reduces the material being formed by at least 40%.

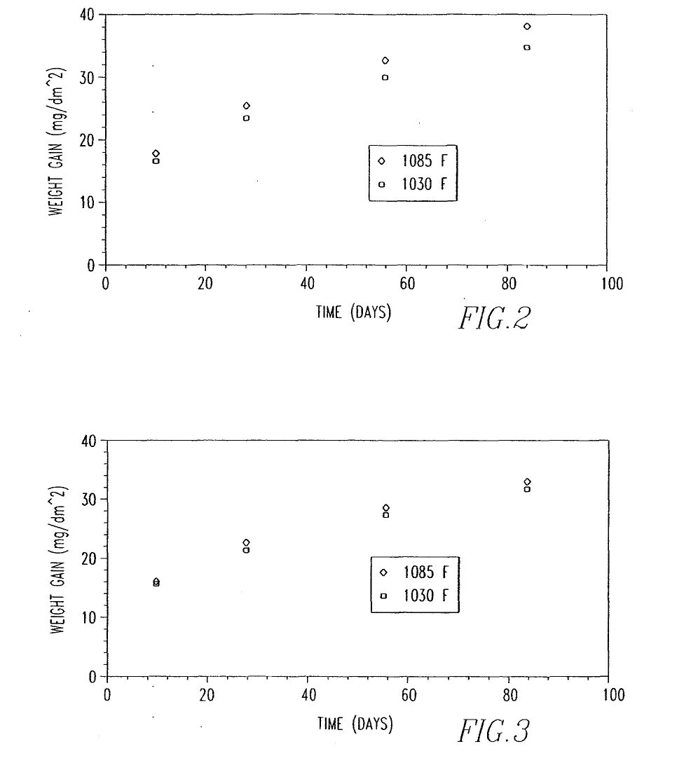

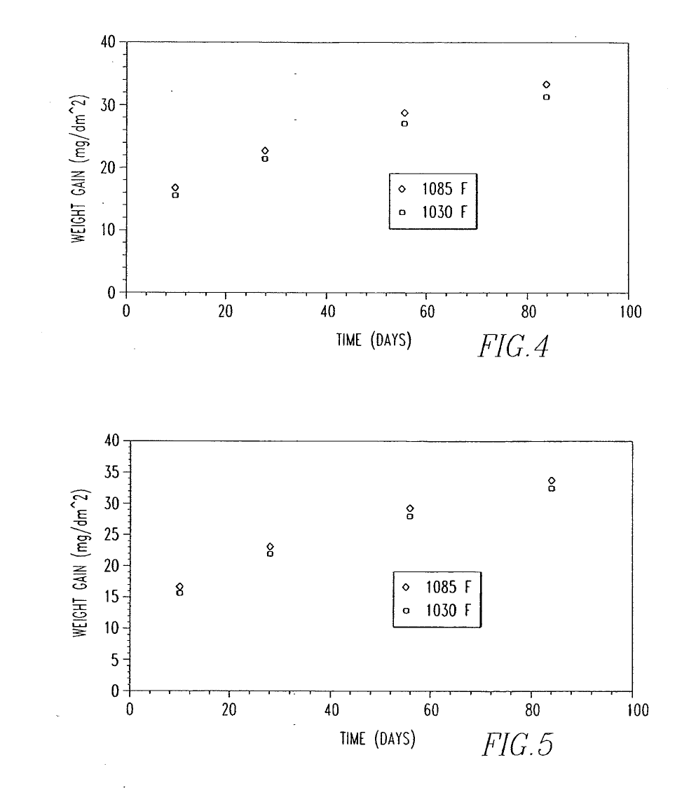

The corrosion resistance was found to improve with intermediate anneals that were consistently in the range of 960°-1105° F., most preferably around 1030°-1070° F., as opposed to typical prior anneal temperatures that are above the 1105° F. for at least one of the temperature anneals. As shown in FIGS. 2-6, a series of preferred alloy embodiments of the present invention were tested for corrosion in a 680° F. water autoclave and measured for weight gain. Tubing material was fabricated from the preferred embodiments of alloys of the present invention, referenced as Alloys X1, X4, X5 and X6, and placed in the 680° F. water autoclave. Data were available for a period of 100 days. Corrosion resistance measured in 680° F. water autoclaves for long term exposure have previously been found to correlate to corrosion resistance data of like alloys placed in-reactor. See Sabol et al., “In-reactor Corrosion Performance of ZIRLO and Zircaloy-4,” Zirconium in the Nuclear Industry: Tenth International Symposium, ASTM STP 1245, 1994, pp. 724-744. The preferred composition of these embodiments, further discussed below, are shown in Table 1. The preferred ranges of the compositions are presented in Table 2.

TABLE 1

| Alloy | Preferred Composition, by weight percentage |
|---|---|
| X1 + Cr | Zr—1.0Nb—0.3Sn—0.12Cu—0.18V—0.05Fe—0.2Cr |
| X4 | Zr—1.0Nb—.05Fe—.25Cr—0.08Cu |
| X5 | Zr—0.7Nb—0.3Sn—0.35Fe—0.25Cr—0.05Ni |
| X6 | Zr—1.0Nb—0.65Sn—0.1Fe |
| X6 + Cr | Zr—1.0Nb—0.65Sn—0.1Fe—0.2Cr |

TABLE 2

| Alloy | Preferred Composition Ranges, by weight percentage |
|---|---|
| X1 | Zr— 0.6-1.5Nb; 0.05-0.4Sn; 0.01-0.1Fe; 0.02-0.3Cu; 0.1- |
| | 0.3V; 0.0-0.5Cr |
| X4 | Zr— 0.6-1.5Nb; 0.01-0.1Fe; 0.02-0.3Cu; 0.15-0.35Cr |
| X5 | Zr— 0.2-1.5Nb; 0.05-0.4Sn; 0.25-.45Fe; 0.15-0.35Cr; |
| | 0.01-0.1Ni |
| X6 | Zr— 0.4-1.5Nb; 0.4-0.8Sn; 0.05-0.3Fe |
| X6 + Cr | Zr— 0.4-1.5Nb; 0.02-0.8Sn; 0.05-0.3Fe; 0.05-0.5Cr |

In order to evaluate the effect of intermediate anneal temperature on corrosion/oxidation, tubing of Standard ZIRLO and Alloys X1, X4 and X5 were processed with intermediate anneal temperatures of 1030 and 1085° F. The alloys of the invention were tested for corrosion resistance by measuring the weight gain over a period of time, wherein the weight gain is mainly attributable to an increase of oxygen (the hydrogen pickup contribution to the weight gain is relatively small and may be neglected) that occurs during the corrosion process. In general, corrosion related weight gain starts quickly and then the rate decreases with increasing time. This initial corrosion/oxidation process is termed as pre-transition corrosion. After a period of time, the corrosion rate increases, approximately linearly with time. This corrosion/oxidation phase is termed post-transition or rapid corrosion. As would be expected, alloys with greater corrosion resistance have lower corrosion rates in the pre- and post-transition phases.

FIGS. 2-6 present 680° F. water corrosion test data. As can be seen in FIGS. 2-6, the weight gain associated with tubing processed with 1030° F. intermediate anneal temperatures was less than for strips processed with higher intermediate anneal temperatures. Further, the weight gains for Alloys X1, X4, X5 and X6 in FIGS. 3-6 were less than that of ZIRLO in FIG. 2. Thus, as the modified alloy compositions and the lower intermediate anneal temperatures exhibit reduced weight gain, and reduced weight gain is correlated with increased corrosion resistance, increased corrosion resistance is directly correlated with the modified alloy compositions and the lower intermediate anneal temperature of the invention. The chemistry formulation of the alloys is correlated with increased corrosion resistance. All of the weight gains from the 680° F. water autoclave testing presented in FIGS. 2-6 are in the pre-transition phase. Although the improvement in the 680° F. water autoclave corrosion weight gain due to lowering of the intermediate anneal temperature appears to be small in view of FIGS. 2-6, the improvement of in-reactor corrosion resistance is expected to be higher than shown by the 680° F. water autoclave data because of in-reactor precipitation of second phase particles in these Zr—Nb alloys and a thermal feedback from a lower oxide conductivity due to lower oxide thickness. Such second phase particle precipitation only occurs in-reactor and not in autoclave testing.

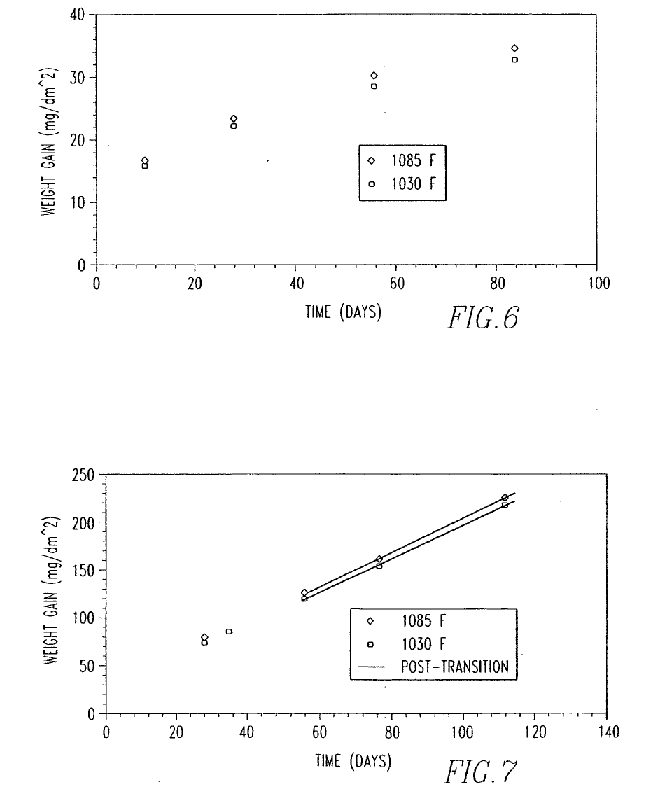

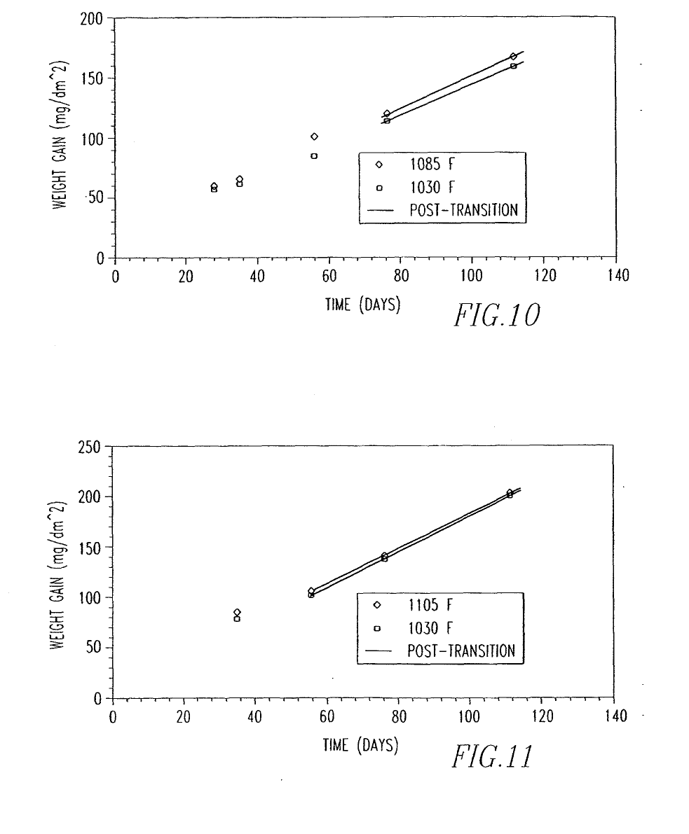

In order to evaluate the effect of intermediate anneal temperature in post-transition corrosion, an 800° F. steam autoclave test was performed, as shown in FIGS. 7-11. The test was performed for sufficient time to achieve post-transition corrosion. Post transition corrosion rates generally began after a weight gain of about 80 mg/dm². Alloys X1, X4, X5 and ZIRLO were processed using intermediate anneal temperatures of 1030° and 1085° F. Alloy X6 tubing was processed using intermediate anneal temperatures of 1030° and 1105° F. The tubing was placed in an 800° F. steam autoclave for a period of about 110 days. FIGS. 7-12 show that the post-transition weight gains of the alloys processed at the intermediate anneal temperature of 1030° F. are less than for alloy materials processed at the higher temperatures of 1085° or 1105° F. Further, the weight gain for Alloys X1, X4, X5 and X6 of FIGS. 8-11 are less than those of the prior disclosed ZIRLO presented in FIG. 7. Thus, the low intermediate anneal temperatures provide substantial improvements over the prior art as it provides a significant advantage in safety, by protecting cladding or the grids from corrosion, in cost, as replacement of the fuel assemblies can be done less often, and through efficiency, as the less corroded cladding better transmits the energy of the fuel rod to the coolant.

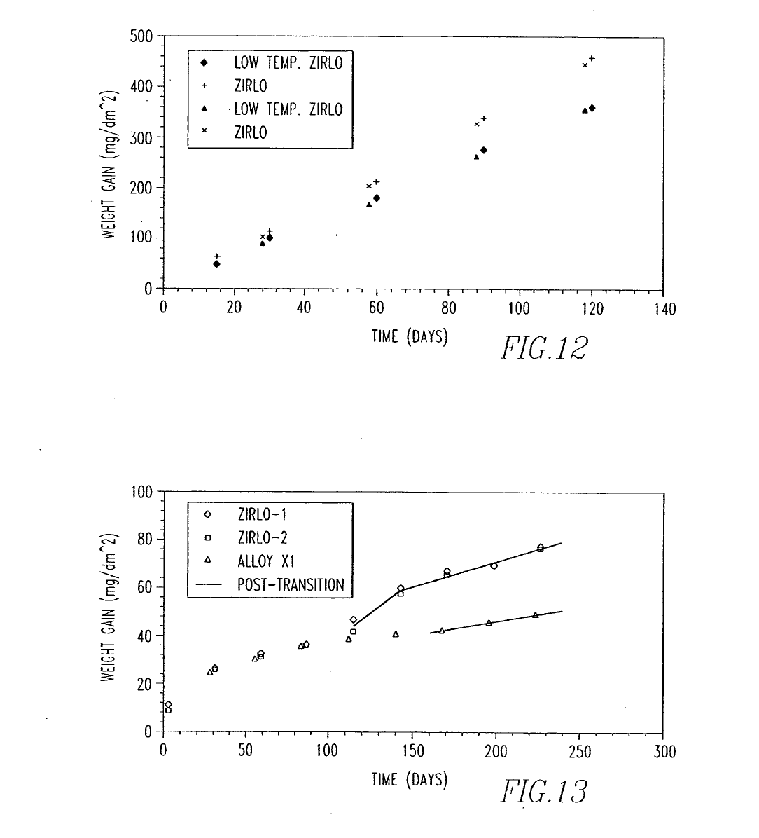

ZIRLO strip was processed with intermediate anneal temperatures of 968 and 1112° F. The material was tested for corrosion resistance by measuring the weight gain over a period of time, wherein the weight gain is mainly attributable to an increase of oxygen (the hydrogen pickup contribution to the weight gain is relatively small and may be neglected) that occurs during the corrosion process. The low temperature strip was processed with an intermediate anneal temperature of 968 and a final anneal temperature of 1112° F. The standard strip was processed with an intermediate anneal temperature of 1112 and a final anneal temperature of 1157° F. FIG. 12 shows that the low temperature processed material exhibits significantly lower corrosion/oxidation than the higher temperature processed material.

The zirconium alloys of the present invention provide improved corrosion resistance through the chemistry of new alloy combinations. The alloys are generally formed into cladding (to enclose fuel pellets) and strip (for spacing fuel rods) in a water based nuclear reactor. The alloys generally include 0.2 to 1.5 weight percent niobium, 0.01 to 0.45 weight percent iron, and at least one additional alloy element from the group consisting of: 0.02 to 0.8 weight percent tin, 0.05 to 0.5 weight percent chromium, 0.02 to 0.3 weight percent copper, 0.1 to 0.3 weight percent vanadium and 0.01 to 0.1 weight percent nickel. The balances of the alloys are at least 97 weight percent zirconium, including impurities. Impurities may include about 900 to 1500 ppm of oxygen.

In general, preferred embodiments of the present invention select at least two additional alloying elements in addition to niobium, iron and zirconium. If only one additional alloying element is selected, the additional alloy will be tin, such that the total weight percent of niobium and tin must be greater than 1 percent, and wherein tin is between 0.4 and 0.8 weight percent, preferably between 0.6 and 0.7 weight percent.

A first embodiment of the present invention is a zirconium alloy having, by weight percent, about 0.6-1.5% Nb; 0.05-0.4% Sn, 0.01-0.1% Fe, 0.02-0.3% Cu, 0.1-0.3% V, 0.0-0.5% Cr and at least 97% Zr including impurities, hereinafter designated as Alloy X1. This embodiment, and all subsequent embodiments, should have no more than 0.50 wt. % additional other component elements, preferably no more than 0.30 wt. % additional other component elements, such as nickel, chromium, carbon, silicon, oxygen and the like, and with the remainder Zr. Chromium is an optional addition to Alloy X1. Wherein chromium is added to Alloy X1, the alloy is hereinafter designated as Alloy X1+Cr.

A preferred composition of Alloy X1 alloy has weight percent ranges for the alloy with about 1.0% Nb; 0.3% Sn, 0.05% Fe, 0.18% V, 0.12% Cu, and at least 97% Zr. A preferred composition of Alloy X1+Cr has weight percent ranges for the alloy with about 1.0% Nb; 0.3% Sn, 0.05% Fe, 0.18% V, 0.12% Cu, 0.2% Cr and at least 97% Zr.

Alloy X1 was fabricated into tubing and its corrosion rate was compared to that of a series of alloys likewise fabricated into tubing, including ZIRLO-type alloys and Zr—Nb compositions. Specifically, the representative alloys were designated as ZIRLO 1, having, by weight percentage, 0.89 Nb, 0.94 Sn, 0.09 Fe, remainder Zr; ZIRLO 2 having 0.97 Nb, 0.97 Sn, 0.11 Fe, remainder Zr; Zr—Nb 1, having 0.9 Nb, 0.02 Fe remainder Zr; and Zr—Nb 2, having 0.97 Nb, 0.05 Fe and remainder Zr.

The post-transition corrosion rates were compared using the 800° F. and 932° F. steam autoclave tests. As shown in Table 3, the composition of Alloy X1 used was the preferred 97% Nb, 0.29% Sn, 0.05% Fe, 0.17% V, 0.17% Cu, and at least 97% Zr.

TABLE 3

| | | POST- | POST- |
|---|---|---|---|
| | | TRANSITION | TRANSITION |
| | COMPOSITION BY | RATE (mg/dm²-d) | RATE (mg/dm²-d) |
| ALLOY | WEIGHT | 800° F. | 932° F. |
| ZIRLO 1 | Zr—.89Nb—.94Sn—.09Fe | 3.10 | 18.6 |
| ZIRLO 2 | Zr—.97Nb—.97Sn—.11Fe | 3.70 | 22.0 |
| Zr—Nb 1 | Zr—.90Nb—.02Fe | — | 5.73 |
| Zr—Nb 2 | Zr—.97Nb—.05Fe | 1.10 | 6.40 |
| Alloy X1 | Zr—.97Nb—.29Sn—.17Cu—.18V—.05Fe | 0.90 | 9.10 |

The results show significantly higher corrosion resistance for products fabricated with Alloy X1 of the present invention as opposed to ZIRLO. Further, the results of Alloy X1 are similar to those of common niobium-iron containing alloys. The corrosion rate of Alloy X1 is slightly less at 800° F. than that the Zr—Nb alloys, whereas the corrosion rate at 932° F. for the Zr—Nb alloys is slightly less than for Alloy X1.

Additionally, Alloy X1, ZIRLO 1 and ZIRLO 2 tubing were placed in a long term 680° F. water autoclave for a period of about 250 days. Alloy X1 was the first preferred embodiment of Alloy X1, with 0.97% Nb; about 0.29% Sn, about 0.05% Fe, about 0.18% V, about 0.17% Cu, and at least 97% Zr; ZIRLO 1 comprises by weight percentage, 0.89 Nb —0.94 Sn —0.09 Fe, remainder Zr, and ZIRLO 2 comprises 0.97 Nb —0.97 Sn —0.11 Fe, remainder Zr. The tubing was measured for weight gain, wherein the weight gain is mainly attributable to an increase of oxygen that occurs during the corrosion process. As shown in FIG. 13, Alloy X1 was similar to the ZIRLO for pre-transition corrosion. However, after about 115 days, ZIRLO exhibited post-transition corrosion and showed significant and rapid weight gain. Alloy X1 of the present invention had significantly lower weight gain for this period, and, in fact, its post transition corrosion rate was barely above its pre-transition weight gain rate. Since 680° F. water autoclave corrosion rates correlate to in-reactor corrosion, the chemistry formulations of Alloy X1 provides substantial improvements over the prior art as it relates to corrosion resistance in a nuclear reactor. This provides a significant advantage in safety, in protecting cladding or the grids from corrosion; in cost, as replacement of the fuel assemblies can be done less often; and in efficiency, as the less corroded cladding better transmits the energy of the fuel rod to the coolant.

A second embodiment of the present invention is a zirconium alloy having, by weight percent, about, about 0.6-1.5% Nb; 0.01-0.1% Fe, 0.02-0.3% Cu, 0.15-0.35% Cr and at least 97% Zr, hereinafter designated as Alloy X4. A preferred composition of Alloy X4 has weight percent ranges for the alloy with about 1.0% Nb, about 0.05% Fe, about 0.25% Cr, about 0.08% Cu, and at least 97% Zr.

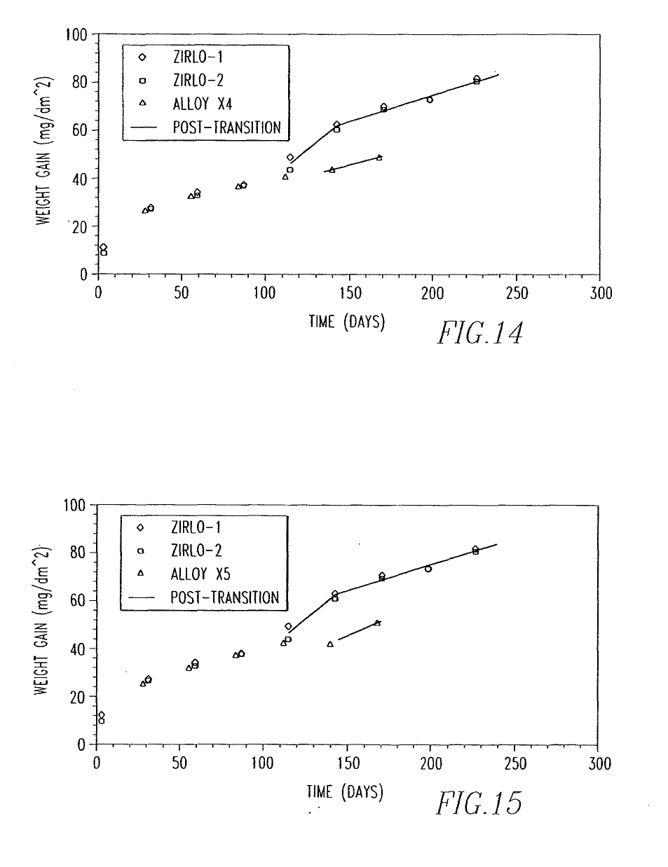

The preferred Alloy X4 was fabricated into tubing and its corrosion rate was compared with the corrosion rate of Standard ZIRLO. Alloy X4 and ZIRLO were each tested for long term corrosion resistance in 680° F. water. Alloy X4, ZIRLO 1 and ZIRLO 2 tubing were placed in a long term 680° F. water autoclave test for a period of about 250 days, wherein Alloy X4 was the preferred embodiment of Alloy X4, ZIRLO 1 comprised, by weight percentage, 0.89 Nb, 0.94 Sn, 0.09 Fe, remainder Zr, and ZIRLO 2 comprised 0.97 Nb, 0.97 Sn, 0.11 Fe, remainder Zr. The tubing was measured for weight gain rates, wherein the weight gain is attributable to an increase of oxygen that occurs during the corrosion process. As shown in FIG. 14, Alloy X4 alloy corrosion rate was similar to ZIRLO during pre-transition corrosion rate. However, after about 115 days, ZIRLO exhibited post-transition corrosion and showed significant and rapid weight gain. The preferred alloys of the present invention had significantly lower weight gain for this period. Since this test correlates to in-reactor corrosion, the chemistry formulations of Alloy X4, like Alloy X1, provides substantial improvements over the prior art as it relates to corrosion resistance in a nuclear reactor.

A third embodiment of the present invention is a zirconium alloy having, by weight percent, about 0.2-1.50% Nb; 0.05-0.4% Sn, 0.25-0.45% Fe, 0.15-0.35% Cr, 0.01-0.1% Ni, and at least 97% Zr, hereinafter designated as Alloy X5. This composition should have no more than 0.5 wt. % additional other component elements, preferably no more than 0.3 wt. % additional other component elements, such as carbon, silicon, oxygen and the like, and with the remainder Zr.

A preferred composition of Alloy X5 has weight percent values for the alloy with about 0.7% Nb; about 0.3% Sn, about 0.35% Fe, about 0.25% Cr, about 0.05% Ni, and at least 97% Zr. Hereinafter, this alloy will be referred to as the first embodiment of Alloy X5.

The preferred embodiment of Alloy X5 was fabricated into tubing and its corrosion rate was compared to that of a series of alloys likewise fabricated into tubing. As shown in Table 4, Alloy A, a low Nb-high Sn predecessor of Alloy X5 (U.S. Pat. No. 5,254,308 having chemical composition ranges of 0.45-0.75% Sn, 0.40-0.53% Fe, 0.2-0.3% Cr, 0.3-0.5% Nb, 0.012-0.03% Ni, 50-200 ppm Si, 80-150 ppm C, 1000-2000 ppm O and the balance Zr), was tested for corrosion resistance in comparison to ZIRLO 1, having, by weight percentage, 0.89 Nb, 0.94 Sn, 0.09 Fe, remainder Zr; ZIRLO 2 having 0.97 Nb, 0.97 Sn, 0.11 Fe, remainder Zr; Zr—Nb 1, having 0.9 Nb, 0.02 Fe remainder Zr; and, Zr—Nb 2, having 0.97 Nb, 0.05 Fe and remainder Zr.

The post-transition corrosion rates were compared using the 800° F. and 932° F. steam autoclave tests. As shown in Table 4, the post-transition rate of the comparative alloys was compared to Alloy A having 0.31 Nb, 0.49 Sn, 0.32 Fe, 0.21 Cr and the balance Zr.

TABLE 4

| | | POST- | POST- |
|---|---|---|---|
| | | TRANSITION | TRANSITION |
| | COMPOSITION BY | RATE (mg/dm²-d) | RATE (mg/dm²-d) |
| ALLOY | WEIGHT | 800° F. | 932° F. |
| ZIRLO 1 | Zr—0.89Nb—0.94Sn—0.09Fe | 3.10 | 18.6 |
| ZIRLO 2 | Zr—0.97Nb—0.97Sn—0.11Fe | 3.70 | 22.0 |
| Zr—Nb 1 | Zr—0.90Nb—0.02Fe | — | 5.73 |
| Zr—Nb 2 | Zr—0.97Nb—0.05Fe | 1.10 | 6.40 |
| Alloy A | Zr—0.31Nb—0.49Sn—0.32Fe—0.21Cr | 0.80 | 7.90 |

Alloy X5 is an improvement over Alloy A because of the decreased Sn content. As can be seen in Table 5, decreases in tin correlate with an increase in corrosion resistance.

TABLE 5

| | | POST- | POST- |
|---|---|---|---|
| | | TRANSITION | TRANSITION |
| ALLOY | COMPOSITION BY | RATE (mg/dm²-d) | RATE (mg/dm²-d) |
| No. | WEIGHT | 800° F. | 932° F. |
| No-tin | Zr—0.94Nb—0.47Fe | 1.40 | 8.60 |
| Low-tin | Zr—0.83Nb—0.27Sn—0.50Fe | 2.00 | 14.3 |
| Normal-tin | Zr—0.99Nb—0.73Sn—0.2Fe | 2.40 | 15.0 |

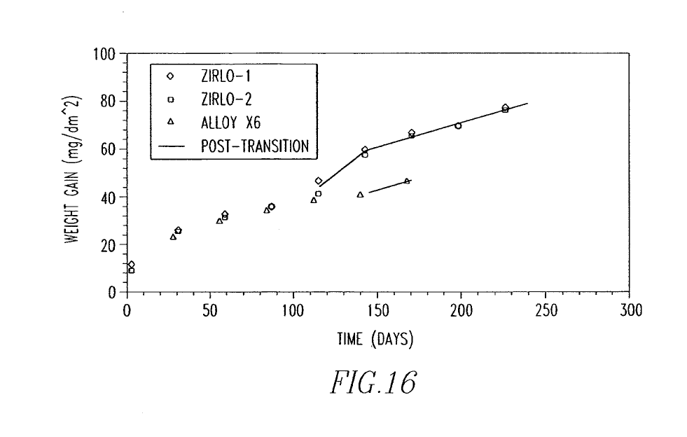

The preferred X5 alloy was further tested for weight gain rates in a long term 680° F. water autoclave and compared to the corrosion resistance of ZIRLO used in the above Alloy X1 and Alloy X4 comparisons. As shown in FIG. 15, Alloy X5 was similar to ZIRLO in the pre-transition corrosion region. However, after about 115 days, ZIRLO exhibited post-transition corrosion and showed significant and rapid weight gain. The preferred alloys of the present invention had significantly lower weight gain for this period. Since this test correlates to in-reactor corrosion, the chemistry formulations of Alloy X5 provides substantial improvements over the prior art as it relates to corrosion resistance in a nuclear reactor.

A fourth embodiment of the invention is a low-tin ZIRLO alloy designated as Alloy X6. As shown in Table 5 above, the reduction of tin in an alloy correlates to an increase in corrosion resistance in high temperature steam environments. Tin, however, increases the in-reactor creep strength, and too small an amount of tin makes it difficult to maintain the desired creep strength of the alloy. Thus, the optimum tin of this alloy must balance these two factors. Thus, the fourth embodiment is a low-tin alloy essentially containing, by weight percent, 0.4-1.5% Nb; 0.4-0.8% Sn, 0.05-0.3% Fe, and the balance at least 97% Zr, including impurities, hereinafter designated as Alloy X6. A preferred composition of Alloy X6 has weight percent ranges of about 1.0% Nb, about 0.65% Sn, about 0.1% Fe, and at least 97% Zr, including impurities.

Tin may be decreased if other alloy elements are included to replace the strengthening effect of tin. A second preferred embodiment of Alloy X6 has generally the same weight percentages plus 0.05-0.5% Cr, hereinafter designated as Alloy X6+Cr. With the addition of Cr, however, the minimum allowable range of tin weight percent may be decreased. Thus, X6+Cr can have 0.4-1.5% Nb; 0.02-0.8% Sn, 0.05-0.3% Fe and 0.05-0.5% Cr. A preferred embodiment of Alloy X6+Cr has about 1.0% Nb, about 0.65% Sn, about 0.1% Fe and about 0.2% Cr.

As shown in FIG. 16, Alloy X6 was tested for weight gain rates in a long term 680° F. water autoclave test relative to ZIRLO. Like the other preferred embodiments of the invention, Alloy X6 was similar to ZIRLO pre-transition corrosion behavior. However, similarly, after about 115 days, ZIRLO exhibited post-transition corrosion and showed significant and rapid weight gain. The preferred alloys of the present invention had significantly lower weight gain for this period. Since this test correlates to in-reactor corrosion, the chemistry formulations of Alloy X6 provides substantial improvements over the prior art as it relates to corrosion resistance in a nuclear reactor.

Weld-Corrosion Resistance

In a typical nuclear fuel assembly large numbers of fuel rods are included. In each fuel rod nuclear fuel pellets are placed within cladding tubes that are sealed by end caps such that the end caps are welded to the cladding. The end cap-cladding weld, however, is susceptible to corrosion to an even greater extent than the non-welded cladding itself, usually by a factor of two.

Zirconium alloys that include chromium show increased weld corrosion resistance. Thus, the addition of chromium in a zirconium alloy includes substantial advancement over prior zirconium alloys that do not include chromium.

Multiplicities of alloys were tested for their effect on weld corrosion, as shown in Table 6. Several alloys were tested for their effect on laser strip welds in a 680° F. water autoclave test for an 84 day period. Some of these alloys had chromium, while the other alloys did not include chromium except in unintentional trace amounts. Still other alloy tube welds were tested in the form of magnetic force welds in an 879-day 680° F. water autoclave test. Each weld specimen placed in the two autoclave tests contained the weld and about 0.25 inches of an end plug and tube on either side of the weld. Separate same length tube specimens without the weld were also included in the test. The weight gain data were collected on the weld and tube specimens. The ratio of the weld corrosion to the non-weld corrosion was determined either from the weight gain data or the metallographic oxide thickness measurements at different locations on the specimen.

TABLE 6

| | | Weld/Base |
|---|---|---|
| | | Corrosion |
| Alloy Name | Composition by weight % | Ratio |
| LASER STRIP | | |
| WELDS | | |
| ZIRLO | Zr—0.95Nb—1.08Sn—0.11Fe | 2.07 |
| Zr—Nb | Zr—1.03Nb | 2.307 |
| ZIRLO modified | Zr—1.06Nb—0.73Sn—0.27Fe | 1.71 |
| ZIRLO/590° C. | Zr—0.97Nb—0.99Sn—0.10Fe | 2.094 |
| RXA | | |
| Alloy A | Zr—0.31Nb—0.51Sn—0.35Fe— | 1.333 |
| | 0.23Cr | |
| MAGNETIC | | |
| FORCE TUBE | | |
| WELDS | | |
| Optin | Zr—1.35Sn—0.22Fe—0.10Cr | 0.805 |
| Zr-4 + Fe | Zr—1.28Sn—0.33Fe—0.09Cr | 0.944 |
| Zr—2P | Zr—1.29Sn—0.18Fe—0.07Ni— | 1.008 |
| | 0.10Cr | |
| Alloy C | Zr—0.4Sn—0.5Fe—0.24Cr | 0.955 |
| Alloy E | Zr—0.4Nb—0.7Sn—0.45Fe— | 1.168 |
| | 0.03Ni—0.24Cr | |

As shown in Table 6, the ratios of the zirconium alloys not having chromium had a weld to base metal corrosion ratio of 1.71 or greater. In contrast, the zirconium alloys containing chromium had a maximum ratio of 1.333 or lower. The chromium additions reduce the ratio of weld corrosion relative to that of the base metal. Thus, the addition of chromium significantly reduces weld corrosion, thereby increasing the safety, cost and efficiency of the nuclear fuel assembly.

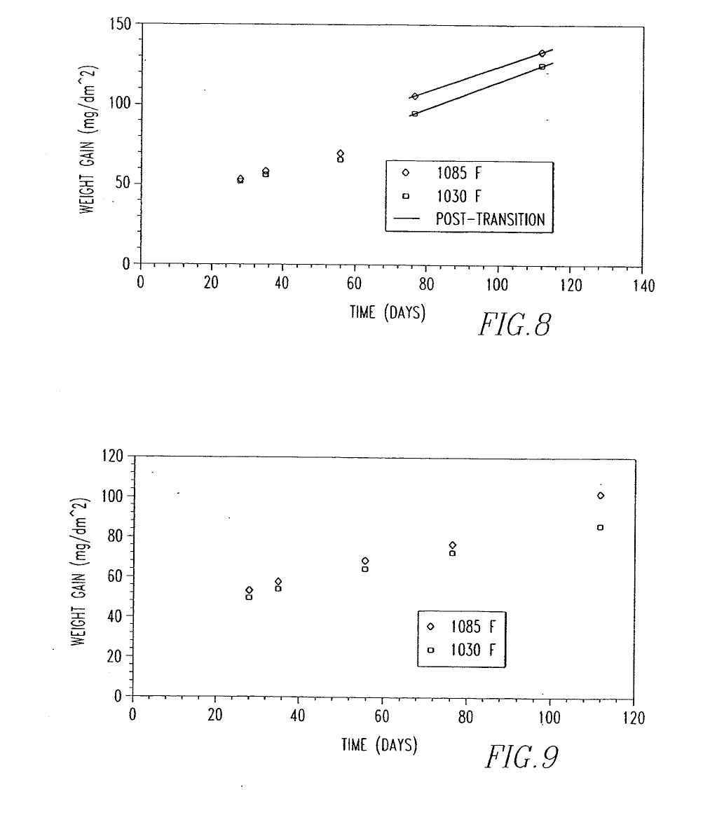

The differences in weld versus base metal corrosion may be explained by differences in vacancy concentration. The weld region is heated to high temperature during welding, and cools at a faster rate than the base material. In a typical increase of temperature, the vacancies in the metal increase exponentially with the temperature. A fraction of the atomic vacancies introduced during the temperature increase are quenched during the cooling of the weld and, as a result, the vacancy concentration is higher in the weld region. Thus, the vacancy concentration is higher in the weld than the heat affected regions of the non-weld region. Since waterside corrosion of zirconium alloys is postulated to occur by vacancy exchange with oxygen ions, increased vacancy concentration in the weld region can increase vacancy/oxygen exchange and thereby increase corrosion in the weld region if the vacancies are not pinned by an alloying element. This exchange will be reduced resulting in improvement of corrosion resistance of the weld. Due to a high solubility of chromium in beta zirconium (about 47% weight percent according to Figure 9.1 in Metallurgy of Zirconium, B. Lustman and F. Kerze Jr., McGraw-Hill Book Company, New York, 1955), chromium is an effective solid solution element to pin the vacancies in the beta phase and thereby decrease the corrosion enhancement due to oxygen ion exchange with supersaturated vacancies in the quenched weld region.

While a full and complete description of the invention has been set forth in accordance with the dictates of the patent statutes, it should be understood that modifications can be resorted to without departing from the spirit hereof or the scope of the appended claims. For example, the time for the intermediate anneals can vary widely while still maintaining the spirit of the invention.

We claim:

1. A zirconium based alloy for use in an elevated temperature environment of a nuclear reactor, the alloy comprising:
0.2 to 1.5 weight percent niobium,
0.01 to 0.45 weight percent iron,
at least two additional alloy elements selected from the group consisting of:
0.02 to 0.45 weight percent tin
0.05 to 0.5 weight percent chromium
0.02 to 0.3 weight percent copper
0.1 to 0.3 weight percent vanadium
0.01 to 0.1 weight percent nickel,
the balance at least 97 weight percent zirconium, including impurities.

2. The zirconium alloy of claim 1, said alloy characterized in that it has improved corrosion resistance properties.

3. The zirconium alloy of claim 1, formulated as a weld material characterized by corrosion resistance.

4. The zirconium alloy of claim 1, wherein the alloy has a composition of
0.6 to 1.5 weight percent niobium,
0.05 to 0.4 weight percent tin,
0.01 to 0.1 weight percent iron,
0.02 to 0.3 weight percent copper,
0.1 to 0.3 weight percent vanadium,
0.0 to 0.5 weight percent chromium,
the balance at least 97 weight percent zirconium, including impurities.

5. The zirconium alloy of claim 4, wherein the alloy has a composition of about
0.97 weight percent niobium,
0.3 weight percent tin,
0.05 weight percent iron,
0.12 weight percent copper,
0.18 weight percent vanadium,
0.2 weight percent chromium,
the balance at least 97 weight percent zirconium, including impurities.

6. The zirconium alloy of claim 4, wherein the alloy is fabricated into a tube for cladding of a nuclear fuel, the alloy having a post-transition corrosion rate (mg/dm²-d) in elevated temperatures of
less than 1.0 when used in 800° F. steam, and
less than 10 when used in 932° F. steam.

7. The zirconium alloy of claim 1, wherein the alloy has a composition of
0.6 to 1.5 weight percent niobium,
0.01 to 0.1 weight percent iron,
0.02 to 0.3 weight percent copper,
0.15 to 0.35 weight percent chromium,
the balance at least 97 weight percent zirconium, including impurities.

8. The zirconium alloy of claim 7, wherein the alloy has a composition of
1.0 weight percent niobium,
0.05 weight percent iron,
0.08 weight percent copper,
0.25 weight percent chromium,
the balance at least 97 weight percent zirconium, including impurities.

9. The zirconium alloy of claim 1, wherein the alloy has a composition of
0.2 to 1.5 weight percent niobium,
0.05 to 0.4 weight percent tin,
0.25 to 0.45 weight percent iron,
0.15 to 0.35 weight percent chromium,
0.01 to 0.1 weight percent nickel,
the balance at least 97 weight percent zirconium, including impurities.

10. The zirconium alloy of claim 9, wherein the alloy has a composition of
0.7 weight percent niobium,
0.3 weight percent tin,
0.35 weight percent iron,
0.25 weight percent chromium,
0.05 weight percent nickel,
the balance at least 97 weight percent zirconium, including impurities.

11. The zirconium alloy of claim 1, wherein the alloy has a composition of
0.4 to 1.5 weight percent niobium,
0.02 to 0.45 weight percent tin,
0.05 to 0.3 weight percent iron,
0.05 to 0.5 weight percent chromium,
the balance at least 97 weight percent zirconium, including impurities.

12. A zirconium based alloy for use in an elevated temperature environment of a nuclear reactor, the alloy comprising:
0.4 to 1.5 weight percent niobium,
0.4 to 0.8 weight percent tin,
0.05 to 0.3 weight percent iron,
the balance at least 97 weight percent zirconium, including impurities.

13. The zirconium alloy of claim 12, wherein the total weight percent of niobium and tin is greater than 1 percent.

14. The zirconium based alloy of claim 12, wherein the alloy has a composition of about:
0.4 to 1.5 weight percent niobium,
0.6 to 0.7 weight percent tin,
0.05 to 0.3 weight percent iron,
the balance at least 97 weight percent zirconium, including impurities.

15. The zirconium based alloy of claim 14, wherein the alloy has a composition of about:
0.4 to 1.5 weight percent niobium,
0.61 to 0.69 weight percent tin,
0.05 to 0.3 weight percent iron,
the balance at least 97 weight percent zirconium, including impurities.

16. The zirconium alloy of claim 15, wherein the alloy has a composition of about:
1.0 weight percent niobium,
0.65 weight percent tin,
0.1 weight percent iron,
the balance at least 97 weight percent zirconium, including impurities

17. The zirconium alloy of claim 12, wherein the alloy further comprises:
0.05 to 0.5 weight percent chromium.

18. The zirconium alloy of claim 17, wherein the alloy has a composition of about
1.0 weight percent niobium,
0.65 weight percent tin,
0.1 weight percent iron,
0.2 weight percent chromium
the balance at least 97 weight percent zirconium, including impurities.

19. The zirconium alloy of claim 12, said alloy characterized by improved corrosion resistance properties.

20. The zirconium alloy of claim 17, formulated as a weld material characterized by improved corrosion resistance.

21. A zirconium based alloy for use in an elevated temperature environment of a nuclear reactor, the alloy comprising:
0.4 to 1.5 weight percent niobium,
0.02 to 0.8 weight percent tin,
0.05 to 0.3 weight percent iron,
0.05 to 0.5 weight percent chromium
the balance at least 97 weight percent zirconium, including impurities.

22. A zirconium based alloy, the alloy comprising:
0.2 to 1.5 weight percent niobium,
0.01 to 0.45 weight percent iron,
at least one additional alloying element selected from the group consisting of:
0.02 to 0.8 weight percent tin
0.05 to 0.5 weight percent chromium
0.02 to 0.3 weight percent copper
0.1 to 0.3 weight percent vanadium
0.01 to 0.1 weight percent nickel,
the balance at least 97 weight percent zirconium, including impurities,
the alloy fabricated from a process comprising the steps of:
forging the zirconium alloy into a material with at least one other element,
beta quenching the material
forming the material with at least one of extruding the material or hot rolling the material,
cold working the material with one or a multiplicity of reducing steps, wherein the one or a multiplicity of reducing steps include
cold reducing the material
annealing the material at an intermediate anneal temperature of 960°-1105° F. finalizing the material.

23. The alloy of claim 22, wherein the at least one additional alloying element selected is tin, and wherein the total weight percent of niobium and tin is greater than 1 percent.

24. The alloy of claim 22, wherein the alloy has a composition of
0.4 to 1.5 weight percent niobium,
0.4 to 0.8 weight percent tin,
0.05 to 0.3 weight percent iron,
the balance at least 97 weight percent zirconium, including impurities.

25. The alloy of claim 22, wherein the alloy is placed with an aqueous environment of a water based nuclear reactor.

26. The alloy of claim 22, wherein the alloy has a composition of
0.4 to 1.5 weight percent niobium,
0.02 to 0.8 weight percent tin,
0.05 to 0.3 weight percent iron,
0.05 to 0.5 weight percent chromium,
the balance at least 97 weight percent zirconium, including impurities.

27. The alloy of claim 22, wherein the alloy has a composition of
0.6 to 1.5 weight percent niobium,
0.05 to 0.4 weight percent tin,
0.01 to 0.1 weight percent iron,
0.02 to 0.3 weight percent copper,
0.1 to 0.3 weight percent vanadium,
the balance at least 97 weight percent zirconium, including impurities.

28. The alloy of claim 25, wherein the alloy is fabricated into a tube for cladding of a nuclear fuel, the alloy having a post transition rate (mg/dm²-d) in elevated temperatures of
less than 1.0 when used in 800° F. steam, and
less than 10.0 when used in 932° F. steam.

29. The alloy of claim 22, wherein the alloy has a composition of
0.6 to 1.5 weight percent niobium,
0.01 to 0.1 weight percent iron,
0.02 to 0.3 weight percent copper,
0.15 to 0.35 weight percent chromium,
the balance at least 97 weight percent zirconium, including impurities.

30. The alloy of claim 22, wherein the alloy has a composition of
0.2 to 1.5 weight percent niobium,
0.05 to 0.4 weight percent tin,
0.25 to 0.45 weight percent iron,
0.15 to 0.35 weight percent chromium,
0.01 to 0.1 weight percent nickel,
the balance at least 97 weight percent zirconium, including impurities.

31. The alloy of claim 22, wherein each of the one or a multiplicity of reduction steps reduces the area of the material at least 40%.

32. The alloy of claim 22, wherein the beta quenching step is conducted at a temperature of about 1273 to 1373° K.

33. The alloy of claim 22, wherein the forming step is extrusion of the material.

34. The alloy of claim 22, wherein the forming step is hot rolling the material.

35. The alloy of claim 33, wherein the cold reducing in the one or a multiplicity of reduction steps is performed by pilgering the material.

36. The alloy of claim 34, wherein the cold reducing in the one or a multiplicity of reduction steps is performed by rolling the material.

37. The alloy of claim 33, wherein finalizing the material includes the step of cold pilgering the material to a final size.

38. The alloy of claim 34, wherein finalizing the material includes the step of cold rolling the material to a final size.

39. The alloy of claim 33, wherein a first intermediate anneal temperature is in a range of about 1030° F. to 1105° F., and an at least one additional intermediate anneal in a temperature range of about 960 to 1070° F.

40. The alloy of claim 39, wherein the tubing is reduced 70-80% prior to the at least one additional intermediate anneal.

41. The alloy of claim 22, wherein each intermediate anneal temperature is in the range of about 1030° F. to 1070° F.

42. The alloy of claim 22, wherein finalizing the material includes forming the material into a cladding for use in a nuclear fuel assembly.

43. A fuel rod for a nuclear reactor, comprising nuclear pellets enclosed in a cladding, the cladding comprising a zirconium based alloy having:
0.2 to 1.5 weight percent niobium,
0.01 to 0.45 weight percent iron,
at least one additional alloy element selected from the group consisting of:
0.02 to 0.8 weight percent tin
0.05 to 0.5 weight percent chromium
0.02 to 0.3 weight percent copper
0.1 to 0.3 weight percent vanadium
0.01 to 0.1 weight percent nickel,
the balance at least 97 weight percent zirconium, including impurities,
the cladding fabricated from a process comprising the steps of:
forging the zirconium alloy into a material with at least one other element,
beta quenching the material
forming the material with at least one of extruding the material or hot rolling the material,
cold reducing the material with one or a multiplicity of reducing steps, wherein the one or a multiplicity of reducing steps include
cold reducing the material
annealing the material at an intermediate anneal temperature of 960°-1105° F. forming the material into the cladding.
